(19) United States
(12) Patent Application Publication
(10) Pub. No.: US 2011/0232516 A1
(43) Pub. Date: Sep. 29, 2011

(54) SYSTEM FOR TRANSFERRING DATA AND USE THEREOF

(75) Inventor: Peter Berner, Rupperswil (CH)

(73) Assignee: XPOSE HOLDING AG

(21) Appl. No.: 13/133,180

(22) PCT Filed: Nov. 25, 2009
(86) PCT No.: PCT/CH09/00378

§ 371 Date: Jun. 7, 2011

(30) Foreign Application Priority Data
Dec. 9, 2008 (EP) 08405301.6

(51) Int. Cl. B41C 3/08

(52) U.S. Cl. 101/401.1

(57) ABSTRACT

The invention relates to a system (21) for transferring data to disk-like data storage media (23, 23′), which system comprises a pick-up (22, 22′) which is at least partially in the form of an inner cylinder and is intended to arrange the data storage media—the side of which that is intended to receive data faces the cylinder axis (29) of the pick-up—and a transfer head (30) which can be rotated about this cylinder axis and has at least two transfer means (24, 24′) for transferring the data to the data storage medium (23), wherein the pick-up (22, 22′) and the transfer head (30) can also be moved relative to one another in the direction of the cylinder axis (29), and the at least two transfer means (24, 24′) comprise a respective array of light sources in order to transfer the data using multi-beam technology. The system (21) is characterized in that the wavelength of the array of light sources of a transfer means (24) differs from the wavelength of the array of light sources of other transfer means (24′), and a control unit (40) is provided in order to alternately switch the transfer means (24, 24′) on and off for the purpose of generating light at different wavelengths.

The invention relates to a system and a method of transferring data to plate-like data storage media and the preferred use of this system, particularly for the exposure of printing plates, flexo plates, screen printing templates or letterpress printing plates.

In the printing industry, different printing processes, such as screen printing, flexo printing, letterpress printing, etc., are often combined. This involves an essential distinction being made between the analog and digital exposure of printing plates. The data contained on a negative or positive film, such as, for example, images, typeface or graphics, is transferred in a copy room or on a step-and-repeat copier machine by means of an ultraviolet light source—in an analog manner—to a light-sensitive printing plate. The quality of the light-sensitive layer is adapted to the light source, so that it exhibits maximum sensitivity, for example, at 380 nm.

The image range of a printing plate is directly depicted by one or more lasers in a digital manner. In this case the sensitivity of the printing plate exhibits a maximum corresponding to the light source. Depending on the wavelength of the light used, conventional offset plates are referred to in the case of visible light and thermal plates in the case of infrared light with, for example, 830 nm.

To transfer data, such as images, typeface or graphics, to data storage media, such as offset printing plates, for example, there are essentially three known exposure principles.

The flat bed, the simplest system for the analog exposure of printing plates is only suitable for digital exposure of the same under certain conditions. On the one hand, the cost of guiding an exposure head increases with the size of the printing plate, while on the other, part of the possible travel range of the exposure system always remains unused through the required exposure speed, due to the necessary start-up and braking ramps of the exposure head.

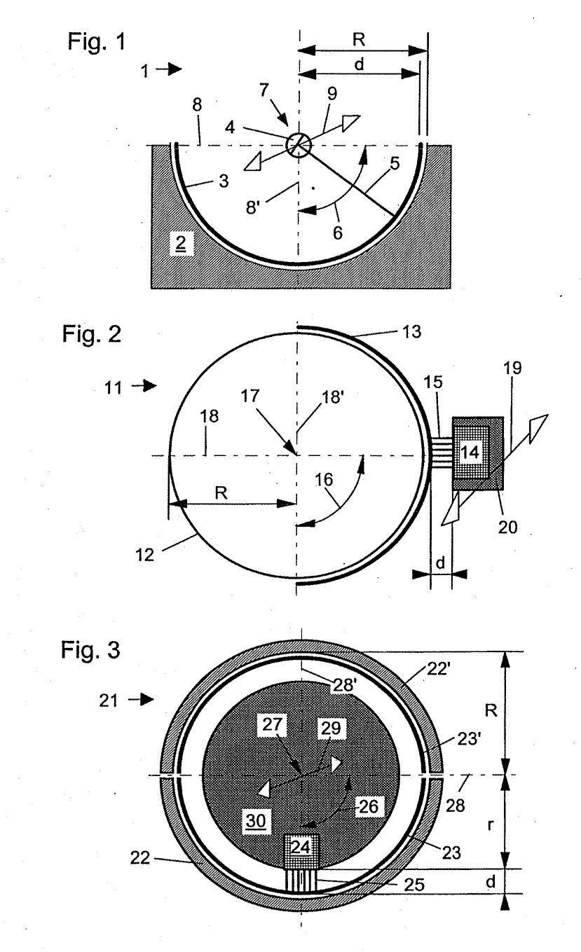

An inner-drum exposure unit known per se (see FIG. 1) exhibits the advantages that the plate size can be selected independently, as the plate does not move during exposure. The plates can be simply placed in the reamed holes provided. An automatic system for supplying the plates and carrying them away can be accomplished relatively easily. Disadvantages that must be cited in relation to this sort of inner-drum exposure unit include having to work with a particularly strong, frequency-doubled YAG laser, in which case a single laser beam is rotated over the plate from the centre of the drum. This makes focussing more difficult on account of the large space and does not allow multiple beam exposure. A polygonal mirror is often used, which is rotated at up to 30,000 rpm. This requires an expensive mounting. In addition, vibrations—whether in the environment of the unit or within the system itself—have a severe impact on the resolution that can be achieved.

In a likewise known outer-drum exposure unit (see FIG. 2), the exposure head may be guided up to a few millimetres from the plate, making it possible to use significantly weaker and more economical laser diodes. These are easier to focus and add as multiple heads, in which case devices with either 256 or 512 laser diodes disposed alongside one another are known. These advantages are offset by the following disadvantages, that the secure attachment of the plate to the drum is very costly in design terms. An unwanted detachment of the plate during exposure cannot be ruled out. Should this happen, however, significant damage to the machine, particularly to the exposure head, can be expected.

The drum speed is limited to approx. 100 rpm, which means that an increase in the size of the area being exposed has a crucial effect on the exposure time. Various plate formats produce a different weight distribution on the drum, which gives rise to the need for automatic balancing during routine operation. Reliable insertion of the plates into the point spurs is very costly, which on the one hand practically requires automation of this process and, on the other, makes it considerably more difficult.

Neither the internal nor the external drum system allows the exposure of several different materials, as they only supply light of one wavelength. This places significant restrictions on the usability of machines, particularly for print shops that require different types of printing plates, such as flexo plates, offset plates, letterset plates or screen printing templates. These sorts of print shops require particularly versatile systems for different applications.

The problem addressed by the present invention is that of proposing an exposure system that can be used particularly flexibly, has a simple structural design, is quick and easy to maintain and can still be manufactured economically. In addition, it should combine many of the individual advantages of the known inner and outer-drum exposure units and eliminate a considerable number of the disadvantages associated with these systems.

This problem is solved by a system according to claim 1.

An essential element of the system according to the invention is that now vastly different materials can be exposed on one and the same machine and this therefore exhibits considerable flexibility. This sort of system is also to be referred to in the following as a hybrid system. This is made possible on the one hand through the use of arrays of light sources, which require less space than a single strong light source. Only in this way can a multiplicity of transfer means be integrated into an inner-drum system and then supply particular wavelengths. The arrays of light sources also allow a rapid data transfer in multiple beam technology. On the other hand, the clear division of wavelengths in the individual transmission means contributes to their modular and compact structure. This is because each transfer means must only be structurally adjusted to one type of light source used, such as, for example, LED or laser diode. In this way, the individual transfer means are also particularly easy to interchange, so that the system can be maintained or reconfigured with little expense.

Preferred developments of the system and preferred uses of the same emerge from the dependent claims in each case.

In a preferred development, it is envisaged that the at least two transfer means are designed to generate light with wavelengths of 375 nm and/or 405 nm and/or 830 nm and/or 904 nm. Having two or more of these wavelengths according to the invention integrated in a single exposure system makes flexible working of materials possible, e.g. in screen printing or offset printing with conventional plates (375 nm, 405 nm) as well as in the offset range with thermal plates (405 nm, 830 nm). In the area of screen printing, for example, both conventional plates and also industrially manufactured and pre-coated screen printing templates can be worked with high printing accuracy for demanding screen printing applications (Screens, Gallus™). The advantage is the simple, economical manufacture, the precise, reproducible data transfer and the high resolution and edge definition. In this case, carbon-coated plates, processless plates (Antem Presstek™), Toyobo™ plates and MacDermid™ plates, for example, can be worked. Even the two wavelengths 405 nm and 830 nm therefore facilitate an already considerable flexibility in printing block production on a single machine.

However, the use of different wavelengths requires a focussing optical system that is adapted to the wavelength being used at the time. So that this optical system does not have to be constantly changed, it is advantageous for a single optical system to be provided to focus the arrays of light sources onto the data storage medium, which can be adapted to light of various wavelengths. This means that a structurally costly changeover mechanism, which requires a constant readjustment of the accuracy of the optical system and is also susceptible to wear and therefore high-maintenance, can be dispensed with.

The optical system preferably exhibits a functional surface coating, such as a reflective element with an electromechanically deformable surface, which is also known as a wave front modulator (Digital Light Processor, DLP). The substrate material of this sort of deformable mirror typically comprises an etched silicon film only a few micrometres thick and one square centimetre large, to which a metal layer and several layers of dielectrics are applied. The dielectric also increases the destruction threshold with the reflectivity. The mirrors are deformed with the help of piezoelectric activators with working frequencies of several kilohertz.

Alternatively, however, it may also be provided that the optical system exhibits a spherically deformable lens element. This sort of lens with a variable focal length is based on, for example, a polymer liquid encapsulated in the lens body. The lens body itself may be made from a polished and anti-reflex-coated substrate on one side and a flexible membrane on the other side. By turning a ring on the lens housing, liquid is pressed out of a reservoir into the lens body, which causes the diaphragm to deform spherically and thereby alters the focal length of the lens. This technology is characterised by favourable costs coupled with high flexibility, quality and precision.

It may, however, also be provided that the optical system exhibits a lens element with a wavelength-adaptive coating. For example, thin, film-like coatings may be used to magnify or reduce the reflection of the surface of an optical component. These may help to increase performance at a given wavelength or across a broad range of wavelengths.

A particularly simple conversion of wavelengths is then possible if the control unit comprises wavelength-dependent parameter sets for the automatic adjustment of the exposure system to a desired wavelength. If another wavelength is required, then one or the other wavelength-dependent parameter set can be activated at the push of a button, so to speak, so that a costly reset of the exposure system can be avoided. A corresponding parameter can likewise be provided for the system's adaptability to hybrid operation. In this way, one and the same piece of software can be used on normal, i.e. single-shaft, and, at the same time, on hybrid, i.e. multi-shaft, systems.

The parameter sets preferably comprise at least operating parameters of the light sources and/or of the transfer head and/or of the transfer means and/or of the optical system. In this way, all system components can be optimally adjusted to the new wavelength. Operating parameters may, in particular, comprise optical, electrical and mechanical system variables, which can be switched depending on the wavelength. These include settings such as, for example, fractional stagger offset, multiscan, laser bias current, laser module type, first and last laser module, first and last active laser, laser type, maximum laser current, laser output power, laser power tolerance, maximum laser power tolerance, laser threshold, digital potentiometer for laser sensor, maximum mean laser current, reference position focus adjustment, plate position detection, etc.

The parameter sets may thereby also comprise wavelength-dependent operating parameters for an electrical linear motor, which is preferably provided to move the transfer head and/or the pick-up. This sort of linear motor allows, on the one hand, particularly accurate and quick axial positioning of the transfer head in the drum. On the other hand, the speed of this motor is particularly precisely adjustable even over a wide speed range. This is necessary, as the working of different materials not only requires different wavelengths. It also calls for a uniformly adapted rotary and axial speed of the transfer head.

A balanced weight distribution in the transfer head of the exposure system is preferably achieved in that the light sources are formed by the ends of light conductors, each of which interacts with a laser diode. In this way, the laser diodes can be disposed separately from the light sources in the transfer head. An imbalance in the head resulting in inaccuracies and greater stabilisation costs is thereby avoided and at the same time the available installation space is more efficiently used.

Particular ease of assembly and good maintainability is achieved if the laser diodes and/or the transfer means have attachments for the detachable connection of the individual light conductors.

It is thereby provided in a preferred way that each of the transfer means exhibits a connection plate with connections disposed on it in grid form, which are particularly easily accessible.

The aforementioned problem is also addressed by a method of transferring data using the system according to the invention, in which the data is transferred to a data storage medium using multi-beam technology and other light sources are switched on and off in each case, depending on the wavelength of the light required in each case.

It is particularly preferable in this case if an automatic system setting is made via parameter sets stored for this purpose, depending on the wavelength required in each case, so as to facilitate large-scale automation of the conversion.

Particularly preferably, operating parameters of the light sources and/or the transfer head and/or the transfer means and/or the optical system are thereby produced, in order to guarantee a comprehensive, precise system setting.

The system according to the invention and the method according to the invention should preferably be used to expose a printing plate, a flexo plate, a screen printing template or a letterpress printing plate.

The device according to the invention is discussed below using schematic drawings. These only depict a preferred embodiment of the invention and should under no circumstances limit the scope of this invention. In the figures:

FIG. 1 shows a cross-section through an inner-drum exposure system (state of the art);

FIG. 2 shows a cross-section through an outer-drum exposure system (state of the art);

FIG. 3 shows a cross-section through an inner-drum exposure system according to the invention and

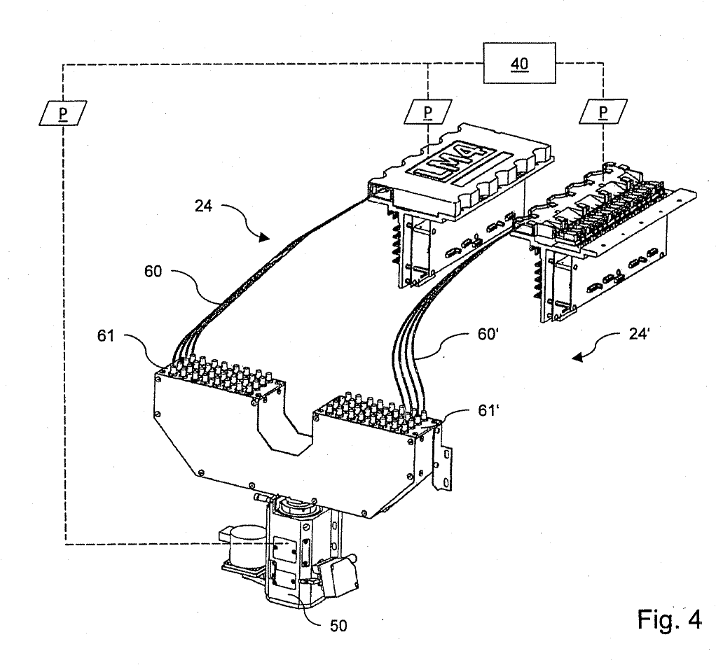

FIG. 4 shows a perspective view of two transfer means and an optical system in an inner-drum exposure system according to the invention.

FIG. 1 shows an inner-drum exposure system 1 known per se with a pick-up 2 at least partially in the form of a cylinder. Inserted in this pick-up is a pressure plate 3, preferably a thermal pressure plate. By means of a rotating transfer means 4, a prism, a beam of light is transmitted onto the surface of the pressure plate 3.

The prism 4 can be rotated in direction 6 about the cylinder axis 7, which runs through the line of intersection of the symmetrical planes 8 and 8′. In this way it is possible, for example, for the entire width of the printing plate 3 to be covered by the light beam or laser beam 5. So that the greatest possible surface area of the plate 3 can come into contact with the laser beam 5, the prism in this example is moved along the cylinder axis 7 in direction 9. The plate 3 may be held in the pick-up 2 by negative pressure, for example, so that the plate likewise assumes an essentially cylindrical or partially cylindrical form. It is thereby made possible for the side of the plate 3 onto which data is to be transferred to be spaced from the centre of rotation of the prism 4 or from the cylinder axis 7 by a practically constant value d. In accordance with the comparatively small thickness of plate 3, the exposure distance d is virtually the same size as the radius R of the cylindrical pick-up 2 or the inner drum.

FIG. 2 shows an outer-drum exposure system 11 known per se with a pick-up 12 at least partially in the form of a cylinder. Placed on this pick-up is a pressure plate 13, preferably a thermal pressure plate. By means of transfer means 14, comprising laser diodes which are attached to a transfer head 20, beams of light 15 are transmitted onto the surface of the pressure plate 13. The transfer head 20 can be moved in direction 17 along the cylinder axis 19, which runs through the line of intersection of the symmetrical planes 18 and 18′. In this way it is possible, for example, for the entire length of the pressure plate 3 to be covered by the light beams or laser beams 15. So that the greatest possible surface area of the plate 13 can come into contact with the laser beams 15, the pick-up or the outer-drum 12 in this example can be rotated about its cylinder axis 17 in direction 19. The plate 13 may be held on the pick-up by negative pressure and/or brackets, for example, so that the plate likewise assumes an essentially cylindrical or partially cylindrical form. It is thereby made possible for that side of the plate 13 onto which data is to be transferred to be spaced from the surface of the transfer means 14 or else from the transfer head 20 by a practically constant value d. In accordance with the comparatively large diameter of the outer-drum 12, the exposure distance d is far smaller than the radius R of the cylindrical pick-up 12 or the outer drum.

FIG. 3 shows in a schematic cross-sectional representation an inner-drum exposure system 21 according to the invention. A pressure plate 23, advantageously a thermal plate, is inserted in the pick-up or in the drums 22. By means of a transfer means 24, which comprises laser diodes and is disposed on a transfer head 30, light beams 25 are transmitted onto the surface of the pressure plate 23. The transfer means comprises an array, i.e. a regular configuration of 24 to 256 light sources. The transfer head 30 is designed as a disc and can be rotated in direction 26 about the cylinder axis 29, which runs through the line of intersection of the planes of symmetry 28 and 28′. In this way, for example, the entire width of the pressure plate 23 can be covered by the light beams or laser beams 25. The transfer head 30 can, in addition, be moved in direction 29 about the cylinder axis 27, which runs through the line of intersection of the planes of symmetry 28 and 28′. In this way, the entire length of the pressure plate 23 can, for example, be covered by the light beams or laser beams 25. The plate 23 may, for example, be held in the pick-up 22 by means of negative pressure, so that the plate likewise assumes an essentially cylindrical or partially cylindrical form.

It is thereby made possible for the side of the plate 23 onto which the data is to be transferred to be spaced from at least one surface of the transfer means 24 or the transfer head 30 by a practically constant value d. In accordance with the comparatively large diameter of the inner drum 22, the exposure distance d is far smaller than the radius R of the cylindrical pick-up 22 or the inner drum. According to the invention, the radius r of the transfer head 30 is selected such that the following is true: r>R/2.

It is thereby made possible for the transfer head 30 to be brought as close as possible to the inserted plate 23 being exposed. The exposure distance d is preferably under 1 cm.

The transfer head 30 is depicted in FIG. 3 as a solid device, but it can also be provided that one or more of the transfer means 24 are movably disposed, so that the distance r between a surface of the transfer means 24 and the cylinder axis 27 is variable. The shape of the transfer head may also differ from that of a disc, although it is always advantageous for a balancing of the transfer head 30 to be possible.

In a variant of this embodiment it may be provided that the pick-up or inner drum comprises two partial shells 22 and 22′. In this way, up to the entire surface of the inner drum can be covered with laser light or other media or beams used to transfer data. Particularly suitable for this are the partial shells 22 and 22′ shown, one or both of which can also be loaded with a pressure plate 23 or 23′ outside the data transfer system 21. In this way, the time taken to charge the system can be shortened still further.

Instead of the negative pressure for holding the pressure plates, other methods such as, for example, static charging of plate 23 and 23′ and/or pick-ups 22 or 22′ are also proposed.

It is important for the transfer means 24 and the surface of the pressure plate 23 being exposed to be movable relative to one another during the data transfer, so that the exposure distance d is as small as possible. Further preferred embodiments of the invention are therefore formulated below, such that the transfer head 30 rotates about the cylinder axis 27 and the inner drum 22 is movable along this cylinder axis 27; such that the transfer head 30 is movable along the cylinder axis 27 and the inner drum rotates about this cylinder axis; such that the transfer head 30 is fixed and the inner drum 22 is both movable along the cylinder axis 27 and also rotates about this cylinder axis, whereby the transfer head can be secured at any point on the transfer system 21, for example on a plane standing perpendicular to the cylinder axis—movably if necessary—on one side of the cylinder. The shape of this sort of transfer head may differ from that of a round disc, because attention need not be focused on balancing. This sort of transfer head 30 or the transfer means 24 may also be disposed non-centrically anywhere within the cylindrical or partially cylindrical pick-up 22.

One possibility for the radial movement of the transfer head 30 or the transfer means 24 for the purposes of adjusting the exposure distance d is preferred in all embodiments, so that a high data transfer resolution and therefore excellent image quality results.

Semiconductor lasers in the form of laser diodes are preferred as transfer media. Other lasers based on semiconductor technology, such as laser transistors, for example, which can be used for the formation of systematic distributions of light sources, so-called arrays, are of course also covered by the basic idea underlying the invention.

It has proved particularly advantageous for all laser modules—where laser diodes are being used—and all electrical power units assigned to these to be rotatably disposed on the transfer head 30 and about the cylinder axis 29 of the pick-up 22, 22′. This configuration enables the electrical energy for operation of the laser diodes with high voltage and low current values to be conducted via a slip ring on the transfer head 30 and converted there, in the electrical performance units on the transfer head 30, into an optimum low voltage with high current for the laser diodes. In addition, it is particularly advantageous for laser diode operation, for each laser diode to be connected to a Peltier element such that it can be cooled, so that a constant operating temperature can be observed. 24 to 256 laser diodes may be provided on the transfer head 30, which each emit their light to a light conductor, which thereby interacts with a laser diode in each case. In a preferred embodiment, laser diodes are disposed on the transfer head 64. 64 fibre optic cables acting as light conductors conduct the 64 individual signals from the 64 laser diodes to an optical system disposed on the transfer head 30. A particularly preferred configuration of the ends of these light conductors is an array, in which these light conductor ends working as light sources are disposed in 8 rows; this configuration produces an optimum distribution of light sources in space terms and therefore an array of 64 light sources with a minimal space requirement. By means of the optical system, the array of light sources is displayed on the data storage medium 23, 23′, particularly on a thermal plate, according to the intensity distribution of the laser diodes. So that there is no banding, meaning an unwanted strip pattern on the data storage medium 23, 23′, the maximum intensity of each laser diode and therefore also each light source can be measured before or also during the data transfer using the system according to the invention and then the maximum intensities of all light sources adjusted to one another. This measuring and adjustment can take place automatically and has the advantage that intensity fluctuations caused by individual ageing of the laser diodes can be corrected in good time.

The configuration according to the invention (cf. FIG. 3) also facilitates the use of one or more solid (=rubidium laser) or gas (=neon, YAG laser) laser. The use of these lasers naturally includes the disposal of special light-conducting means, such as mirrors and the like. This use is facilitated by a correspondingly solid and voluminous transfer head 30 design.

Advantages of the data transfer according to the invention to data storage media or else the exposure of printing plates combine the advantages of the inner-drum concept (independent plates size, simple charging of the exposure unit, possible automation of the plate feed) with the advantages of the outer-drum principle (exposure gap of a few millimetres, use of laser diodes), so that in multi-beam technology e.g. by means of arrays of light conductors interacting with laser diodes, a small gap can be achieved between the optical system and the printing plate.

FIG. 4 shows a perspective view of two transfer means 24, 24′ and an optical system 50 in an inner-drum exposure system according to the invention. At their one end, the light conductors 60, 60′ are connected to grid-shaped connections disposed on connection plates 61, 61′, and on their opposite ends with laser diodes or LEDs of the transfer means 24, 24′. In this way, the transfer means 24 supplies light with a wavelength of 405 nm and the transfer means 24′ light with a wavelength of 830 nm. The grid-shaped configuration of the light conductors 60, 60′ each produces an array of light sources of one wavelength.

The light conductors 60, 60′ thereby allow a spatially separate configuration of the laser diodes and light sources, which can thereby be easily integrated, e.g. in a transfer head 30, as shown in FIG. 3. At the same time, by positioning them accordingly, it is possible to avoid weight imbalances occurring in the head 24. Via the optical system 50, the arrays from light sources of each transfer means can be focused on the material being worked. A control unit 40 envisages parameter sets in this case.

A control unit 40 thereby allows an effortless changeover of the transfer means 24, 24′ from one wavelength to another, for targeted working of corresponding materials. With the aforementioned wavelengths, screen printing and offset printing applications in particular are covered. For adjustment of the transfer means 24, 24′ and the optical system 50, corresponding parameter sets P are stored on the control unit 40, which are transmitted, in order to adjust these components to a desired wavelength. The movement of the transfer head can also be adjusted accordingly via these parameter sets. Through multiplication of the transfer means 24, 24′ and corresponding coupling with the optical system 50, further wavelengths can of course also be made available, e.g. 375 nm, 940 nm and 950 nm. The parameter sets P then have to be increased by corresponding operating parameters. In each case, the control unit 40 makes a high-grade automation of the hybrid system possible, so that it is made significantly easier to handle, despite flexible application possibilities.

The optical system 50 need not necessarily be set via sets of parameters, but it may also have adaptive charging, which permits focussing of the different wavelengths. What is preferred, however, is a wavelength-dependent adjustment of the optical system 50, e.g. via a polymer lens or a DLP, so that a particularly precise adjustment to different wavelengths—including more than two—can be undertaken.

In the present application, a precise description of the technical details, such as the transfer of data to rotating transfer means (for example, by means of light conductors), the making of electrical contacts by means of sliding contacts, was dispensed with in the interests of keeping the application brief. The solving of such detail problems naturally falls within the know-how and ability of a person skilled in the art entrusted with addressing such a problem.

1. A system for transferring data to plate-like data storage media, which system comprises a pick-up which is at least partially in the form of an inner cylinder and is intended to arrange the data storage media—the side of which that is intended to receive data faces the cylinder axis of the pick-up—and a transfer head which can be rotated about this cylinder axis and has at least two transfer means for transferring the data to the data storage medium, wherein the pick-up and the transfer head can also be moved relative to one another in the direction of the cylinder axis, wherein the at least two transfer means comprise a respective array of light sources in order to transfer the data using multi-beam technology, wherein the wavelength of the array of light sources of a transfer means differs from the wavelength of the array of light sources of other transfer means, that the light sources have an optically conductive connection with laser light generators spatially separate from the light sources by means of light conductors and that a control unit is provided in order to alternately switch the transfer means on and off for the purpose of generating light at different wavelengths.

2. The system according to claim 1, wherein the at least two transfer means are designed to generate light with wavelengths of 375 nm and/or 405 nm and/or 830 nm and/or 904 nm.

3. The system according to claim 1, wherein a single optical system is provided to focus the arrays of light sources onto the data storage medium, which can be adapted to light at different wavelengths.

4. The system according to claim 3, wherein the optical system exhibits a reflective element with an electromechanically deformable surface.

5. The system according to claim 3, wherein the optical system exhibits a spherically deformable lens element.

6. The system according to claim 3, wherein the optical system exhibits a lens element with a wavelength-adaptive coating.

7. The system according to, claim 1, wherein the control unit comprises wavelength-dependent parameter sets (P) for the automatic adjustment of the exposure system to a desired wavelength.

8. The system according to claim 7, wherein the parameter sets (P) comprise at least operating parameters of the light sources and/or of the transfer head and/or of the transfer means and/or of the optical system.

9. The system according to, claim 1, wherein a distance (d) between at least one surface of the transfer head or else the transfer means and the data storage medium—during the transfer of data—is less than ¼ of the pick-up diameter.

10. The system according to claim 1, wherein the distance (d) between at least one surface of the transfer head (30) or else the transfer means and the data storage medium—during the transfer of data—is less than 1 cm.

11. The system according to claim 1, wherein the transfer head is movably disposed in the direction of the cylinder axis of the pick up.

12. The system according to claim 1, wherein the pick-up is movably disposed along its cylinder axis.

13. The system according to claim 11, wherein an electric linear motor is provided to move the transfer head and/or the pick-up.

14. The system according to claim 1, wherein the array comprises 16 to 256 light sources.

15. The system according to claim 1, wherein the array comprises 64 light sources.

16. The system according to claim 15, wherein the 64 light sources are disposed in 8 rows.

17. The system according to claim 1, wherein the transfer head comprises an optical system for displaying the array of light sources on the data storage medium.

18. The system according to claim 1, wherein the transfer means comprise semiconductor lasers, particularly laser diodes.

19. The system according to claim 18, wherein the light sources are formed by the ends of light conductors, each of which interacts with a laser diode.

20. The system according to claim 19, wherein the laser diodes and/or the transfer means have attachments for the detachable connection of the individual light conductors.

21. The system according to claim 20, wherein the transfer means each exhibit a connection plate with connections disposed on it in grid form.

22. The system according to claim 20, wherein each laser diode is connected to a Peltier element such that it can be cooled.

23. The system according to claim 20, wherein all laser modules and all electrical power units assigned to these are rotatably disposed on the transfer head and about the cylinder axis of the pick up.

24. A method of transferring data using a system according to claim 1, wherein the data is transferred to a data storage medium using multi-beam technology and other light sources are switched on and off in each case, depending on the wavelength of the light required in each case.

25. The method according to claim 24, wherein an automatic system setting (21) is made via parameter sets (P) stored for this purpose, depending on a wavelength required in each case.

26. The method according to claim 24, wherein at least one setting of operating parameters of the light sources and/or the transfer head and/or the transfer means and/or an optical system is performed.

27. The method according to claim 24, wherein a printing plate or a flexo plate or a screen printing template or a letterpress printing plate is exposed.

28. The method according to claim 24, wherein the maximum intensity of each light source is individually measured before or during the data transfer.

29. The method according to claim 28, wherein the maximum intensities of all light sources are adjusted to one another to avoid banding.

30. The method according to claim 24 further comprising exposing printing plates, flexo plates, screen printing templates or letterpress printing plates.
